(19) United States
(12) Patent Application Publication
(10) Pub. No.: US 2008/0300906 A1
(43) Pub. Date: Dec. 4, 2008

(54) FACILITY CONTROL SYSTEMS AND FACILITY CONTROL METHOD

(75) Inventors: Yusuke Doi, Yokohama-shi (JP); Masahiro Ishiyama, Kawasaki-shi (JP); Tomonori Maegawa, Tokyo (JP); Yu Kaneko, Yokohama-shi (JP)

Correspondence Address: Charles N.J. Ruggiero, Esq.;Ohlandt, Greeley, Ruggiero & Perie, L.L.P., 10th Floor, One Landmark Square, Stamford, CT, 06901-2682, US

(73) Assignee: Kabushiki Kaisha Toshiba

(21) Appl. No.: 12/050,839

(22) Filed: Mar. 18, 2008

(30) Foreign Application Priority Data
May 29, 2007 (JP) 2007-142205

(51) Int. Cl. G06Q 99/00

(52) U.S. Cl. 705/1

(57) ABSTRACT

A facility control system for controlling devices shared in spaces, a plurality of operation units being equipped in the spaces respectively, each operation unit configured to input a operation request for operating the devices, calculates a priority level of each space during the reservation time of each space based on at least one of the use purpose of each space and the attribute information of each user of each space, detects a type of the operation request input from each operation unit provided in each space, detects, whenever the type of the operation request is detected for each space, a collision between types of the latest operation requests detected for respective spaces based on the types, and operates the devices according to one of the types which is detected for one of the spaces whose priority level is highest when the collision is detected.

### CROSS-REFERENCE TO RELATED APPLICATIONS

This application is based upon and claims the benefit of priority from prior Japanese Patent Application No. 2007-142205, filed May 29, 2007, the entire contents of which are incorporated herein by reference.

### BACKGROUND OF THE INVENTION

1. Field of the Invention

The present invention relates to a control method and apparatus for controlling devices shared in a plurality of spaces.

2. Description of the Related Art

There has been disclosed a system which stores, in advance, an operating schedule comprising combinations of operating times and operating devices (a TV conference system, slide, overhead projector, and the like), and when the use of a room such as a conference room is reserved, executes a procedure for operating an air conditioning device, lighting device, curtain, and the like so as to make the room have an environment suitable for the purpose of use at the reservation time and allowing the operating devices set in the operating schedule to be used at the reservation time (see, for example, JP-A H9-128446(KOKAI)).

Consider actual facilities. Assume that one facility is assigned to a plurality of sections (e.g., two sections, namely the “first conference room” and “second conference room”) significant to users. For example, a conceivable situation is that when one room used as a conference room in the past is partitioned into two conference rooms, although lighting devices and the outlets of an air conditioner are separately provided, the part which cools air is shared by the two conference rooms.

Consider a facility in which a plurality of spaces (the first and second conference rooms in this case) share one device (e.g., a lighting device). When such a facility is to be used, the following problem arises. Assume that the lighting device shared by the two conference rooms takes two values, namely ON and OFF. Assume that each conference room is equipped with an operation unit for operating the lighting device, and each operation unit has three buttons, namely “conference”, “presentation”, and “disconnection (nonuse)”. Obviously, the lighting device is required to be ON during a conference and be OFF during a presentation.

If one of the first and second conference rooms is in the state of “conference”, and the other is in the state of “disconnection (nonuse)”, it suffices to turn on the lighting device. In contrast, if one room is in the state of “conference” and the other room is in the state of “presentation”, the request to turn on the lighting device collides with the request to turn it off.

When a provided facility is to be used according to the convenience and tastes of users who use the facility, there is no way to avoid the above collision. When such a collision arises, it is necessary to determine how to handle this, i.e., whether to turn on or off the lighting device in the above facility.

Under the circumstances, the present invention provides a facility control system and apparatus which can control one or a plurality of shared devices shared in a plurality of spaces so as to optimize the use of the devices in accordance with the use state of each space.

### BRIEF SUMMARY OF THE INVENTION

According to embodiments of the present invention, a facility control system for controlling one or more devices shared in a plurality of spaces, a plurality of operation units being equipped in the spaces respectively, each operation unit configured to input a operation request for operating the devices; the system includes:

a first memory to store, for each space, a use schedule including a reservation time, a use purpose of the space during the reservation time, and users of the space during the reservation time;

a second memory to store attribute information of each user;

a priority calculation unit configured to calculate a priority level of each space during the reservation time of each space based on at least one of the use purpose of each space and the attribute information of each user of each space;

a first detection unit configured to detect a type of the operation request input from each operation unit provided in each space;

a second detection unit configured to detect, whenever the type of the operation request is detected by the first detection unit for each space, a collision between types of the latest operation requests detected for respective spaces based on the types; and

a control unit configured to operate the devices according to one of the types which is detected for one of the spaces whose priority level is highest when the collision is detected.

### BRIEF DESCRIPTION OF THE SEVERAL VIEWS OF THE DRAWING

FIG. 1 is a view showing an example of a facility to which a facility control system according to the first embodiment is applied;

FIG. 2 is a block diagram showing an example of the arrangement of the facility control system according to the first embodiment;

FIG. 3 is a view showing an example of a use schedule for a first conference room R1 stored in a state management DB;

FIG. 4 is a view showing an example of a use schedule for a second conference room R2 stored in the state management DB;

FIG. 5 is a view showing an example of storage of user attribute information stored in a user management DB;

FIG. 6 is a view showing an example of a first control table stored in the state management DB;

FIG. 7 is a view showing an example of a priority table stored in the state management DB;

FIG. 8 is a flowchart for explaining the processing operation of a facility control system;

FIG. 9 is a view showing an example of a state table for each space which is stored in a state table storage unit;

FIG. 10 is a view showing an example of a priority table according to the second embodiment;

FIG. 11 is a block diagram showing an example of the arrangement of a facility control system according to the fourth embodiment;

FIG. 12 is a view showing an example of a second control table stored in a state management DB in FIG. 11; and

FIG. 13 is a view showing an example of a first control table stored in the state management DB in FIG. 11.

### DETAILED DESCRIPTION OF THE INVENTION

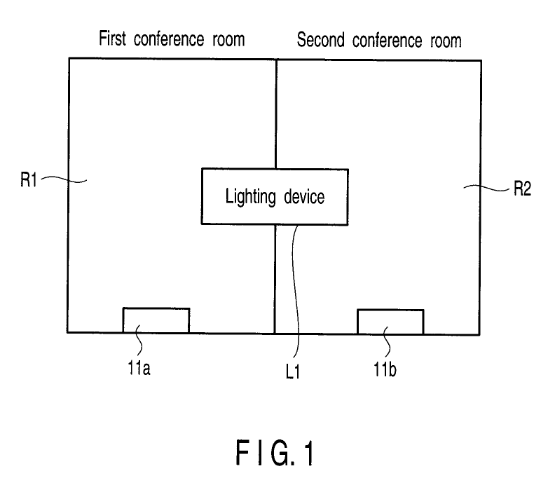

FIG. 1 shows a case in which one shared device (e.g., a lighting device) L1 is used in a plurality of spaces (e.g., first and second conference rooms R1 and R2 in this case). The first and second conference rooms R1 and R2 are respectively equipped with operation units 11a and 11b for operating the lighting device L1. Users of the respective conference rooms ON/OFF-control the lighting device L1 by operating the operation units 11a and 11b.

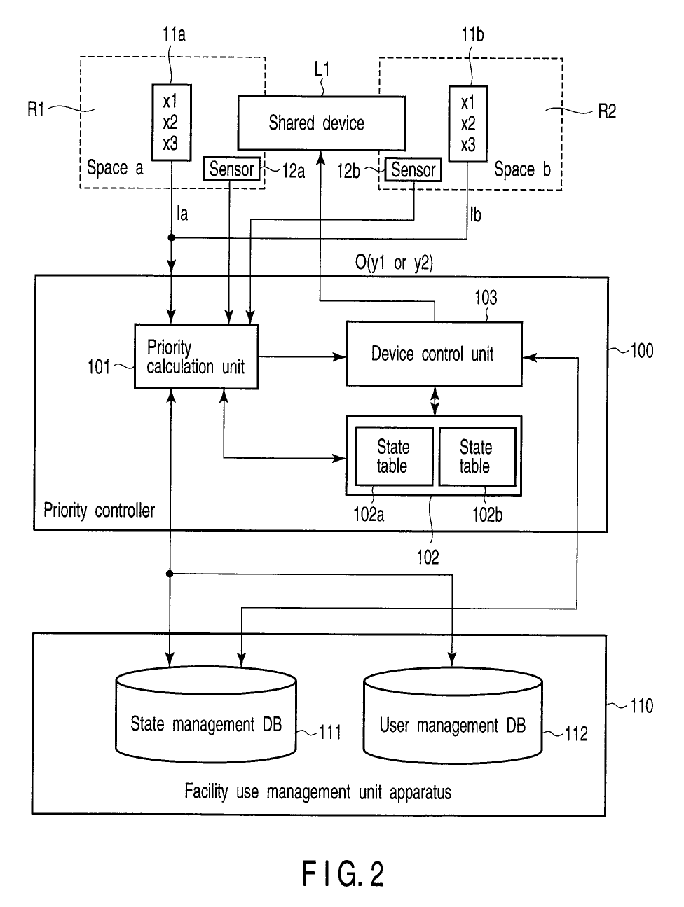

FIG. 2 shows an example of the arrangement of a facility control system used for the first and second conference rooms in FIG. 1.

Referring to FIG. 2, the first conference room R1 in FIG. 1 corresponds to a space a in FIG. 2, and the second conference room R2 in FIG. 1 corresponds to a space b in FIG. 2. The lighting device L1 in FIG. 1 corresponds to the shared device L1 in FIG. 2. FIG. 2 shows a case in which a plurality of spaces (e.g., two spaces in this case) share one shared device. However, the present invention is not limited to this, and the spaces can share a plurality of devices.

As shown in FIG. 2, the facility control system includes the shared device L1, the operation units 11a and 11b for operating the shared device L1 in the respective spaces, a priority controller 100, and a facility use management unit apparatus 110.

The operation units 11a and 11b provided in the respective spaces are so-called switches each to which one of a plurality of types of values (e.g., three types of values x1, x2, and x3 in this case) is input as an operation request to the shared device L1.

The facility control system in FIG. 2 sets the lighting device L1 in either the ON state or the OFF state on the basis of the operation requests input from the operation units 11a and 11b, the use purposes of the spaces R1 and R2, user attributes, and the like.

The priority controller 100 includes a priority calculation unit 101, state table storage unit 102, and device control unit 103. The state table storage unit 102 stores state tables corresponding to the respective spaces. For example, state tables 102a and 102b respectively correspond to the spaces R1 and R2.

The facility use management unit apparatus 110 includes a state management database (state management DB) 111 and a user management database (user management DB) 112.

Assume that the spaces R1 and R2 are first and second conference rooms in accordance with FIG. 1, and the shared device L1 is a lighting device in accordance with FIG. 1.

As operation requests to the lighting device L1 which are input from the operation units 11a and 11b, three types of values, namely “ON”, “OFF”, and “NULL” can be set. Although these three types of operation requests are provided from the facility provider side, users can freely discriminate and use the three types of operation requests.

Consider, for example, a case in which a user discriminates these three types of operation requests as “conference”, “presentation”, and “disconnection (nonuse)”. In this case, the user associates, for example, “conference” with “ON” of the lighting device L1, “presentation” with “OFF” of the lighting device L1, and “disconnection (nonuse)” with “NULL” of the lighting device L1. Note that such setting table set on the user side can be stored in the state management DB 111.

The operation units 11a and 11b each have buttons corresponding to the respective operation requests. When the user presses the “conference” button, an operation request to turn on the lighting device L1 is output to the priority controller 100. When the user presses the “presentation” button, an operation request to turn off the lighting device L1 is output to the priority controller 100. “NULL” associated with the “disconnection” button is set to “OFF”. When the user presses the “disconnection” button, an operation request to turn off the lighting device L1 is output to the priority controller 100. Assume that in this case, the user can arbitrarily set “NULL” to “ON”, “OFF”, or “NULL” as it is.

The state management DB 111 stores the use schedules for the first and second conference rooms R1 and R2.

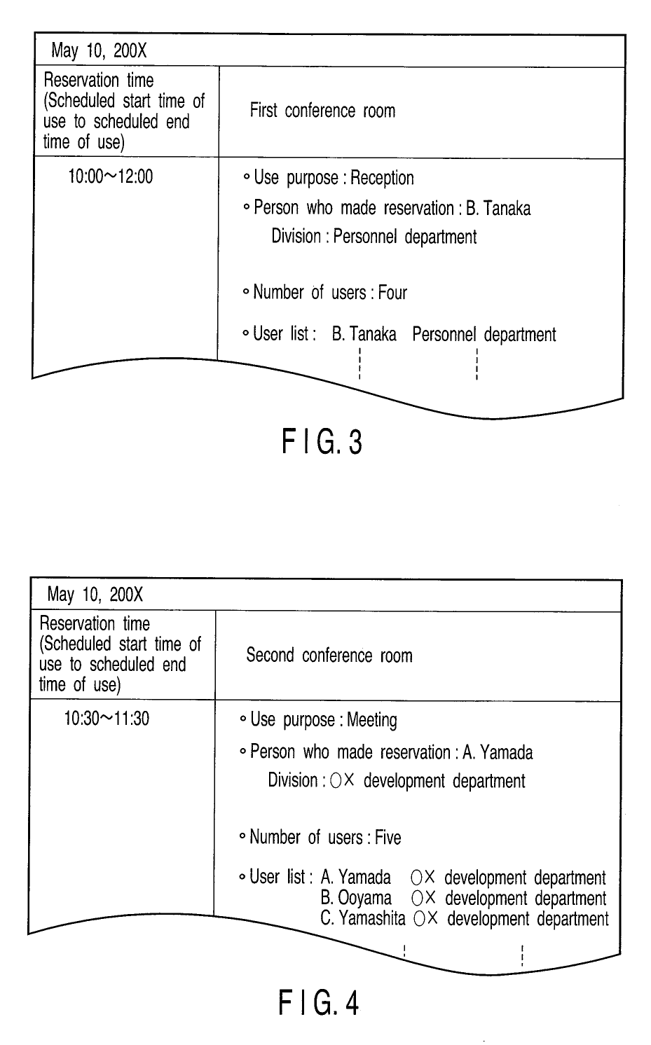

As shown FIGS. 3 and 4, each use schedule includes a date (year, month, and day) and a time zone (reservation time) during which the corresponding conference room is used. In addition, each use schedule includes, the use purpose of the conference room, the person who has made the reservation, the division to which the person belongs, the number of users of the conference room, a list of users of the conference room, and the like, which are associated with each other.

“Reservation time” includes the scheduled start time of use of the conference room and the scheduled end time of use of the conference room. The starting time of the “Reservation time” is the scheduled start time of use, the end time of the “Reservation time” is the scheduled end time of use. As use purposes of each conference room, “liaison conference”, “job training”, “meeting”, “reception”, and the like are set in advance. One of these purposes is selected as “user purpose” in the use schedule. The user list includes the names, divisions, and the like of users who use the corresponding conference room in the corresponding time zone.

Each user can access the state management DB 111 from his/her terminal via a network. For example, the person who is to reserve the first conference room accesses the state management DB 111 and registers a use schedule like that shown in FIG. 3 in the state management DB 111.

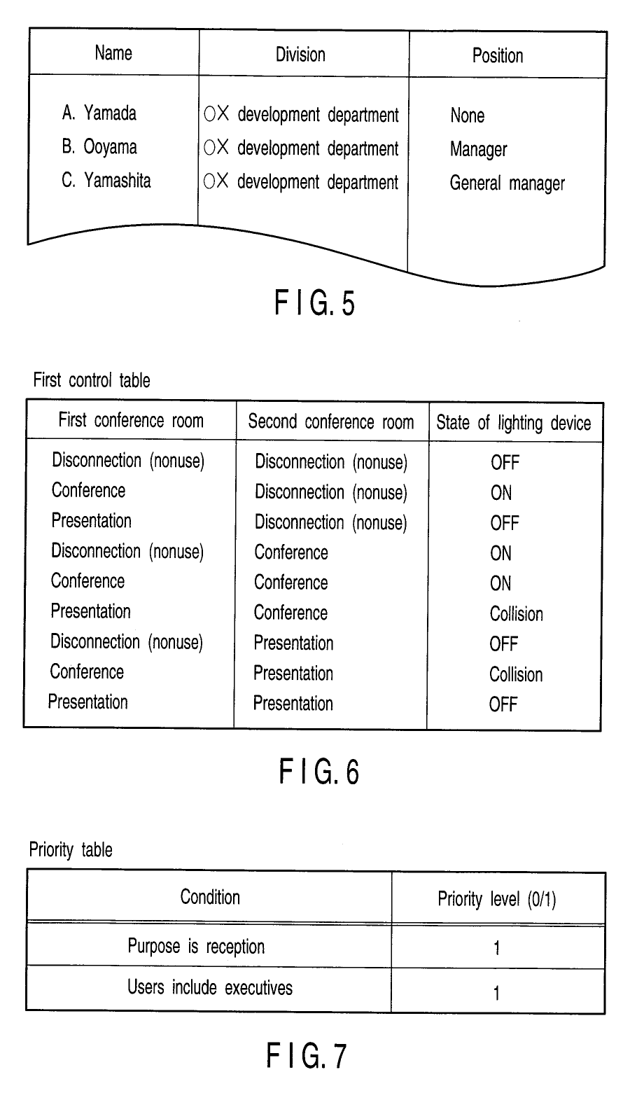

The user management DB 112 stores attribute information such as the names, divisions, positions, and the like of all users who can use the first and second conference rooms in FIG. 1, as shown in FIG. 5.

The state management DB 111 also stores a first control table indicating the states (ON, OFF, and collision) corresponding to combinations of operation requests from the operation units 11a and 11b in the respective conference rooms.

Note that each user can access the state management DB 111 from his/her terminal via a network. For example, a user having the right to register and update data in the first control table accesses the state management DB 111 from his/her terminal to register/update the first control table like that shown in FIG. 6.

As shown in FIG. 6, if an operation request from one of the first and second conference rooms is “disconnection (nonuse)”, the lighting device L1 is set in the state corresponding to an operation request from the other conference room. If an operation request from the first conference room is “disconnection (nonuse)”, and an operation request from the second conference room is “conference”, the lighting device L1 may be set in the ON state. If an operation request from the second conference room is “presentation”, the lighting device L1 may be set in the OFF state. If both operation requests from the first and second conference rooms are “conference”, the lighting device L1 may be set in the ON state. If both operation requests from the first and second conference rooms are “presentation”, the lighting device L1 may be set in the OFF state.

Assume that an operation request from one of the first and second conference rooms is “conference”, and an operation request from the other conference room is “presentation”. In this case, the operation request “conference” requires to turn on the lighting device L1, whereas the operation request “presentation”, which conflicts with the former request, requires to turn off the lighting device L1. That is, the operation requests collide with each other, and the lighting device L1 is set in the collision state.

When such a collision occurs, the priority controller 100 calculates priority levels corresponding to the operation requests from the two conference rooms on the basis of the use purposes of the respective conference rooms in the use schedules stored in the state management DB 111, the attributes of the users of the respective conference rooms stored in the user management DB 112, and the like as well as the operation requests input from the operation units 11a and 11b.

Note that each user can arbitrarily set determination criteria for priority levels.

The priority table in FIG. 7, which is for determining priority levels, is set by a user. The priority table is preferably stored in, for example, the state management DB 111 which each user can access from his/her terminal via a network. However, it suffices to store the table in the priority calculation unit 101. In either case, this priority table is stored so as to allow a user having the right to set and update data to set and update data.

Assume that in this case, each priority level takes two values, namely “0” and “1”, and “1” takes priority over “0”. The priority table shown in FIG. 7 indicates conditions assigned with “1” as a priority level. In this case, each condition is associated with a use purpose of each conference room or an attribute of a user. If at least one of the plurality of conditions listed in this priority table is satisfied, the priority level corresponding to the conference room and the operation request is set to “1”. If none of the conditions listed in the priority table in FIG. 7 is matched, the priority level is set to “0”.

In the priority table in FIG. 7, the use purpose “reception” indicates that a person outside the company (or outside the division) is likely to have visited. If, therefore, “reception” is matched, the priority level is set to “1”. If the user list includes an executive, the corresponding conference is regarded as an important conference. The priority level is therefore set to “1”.

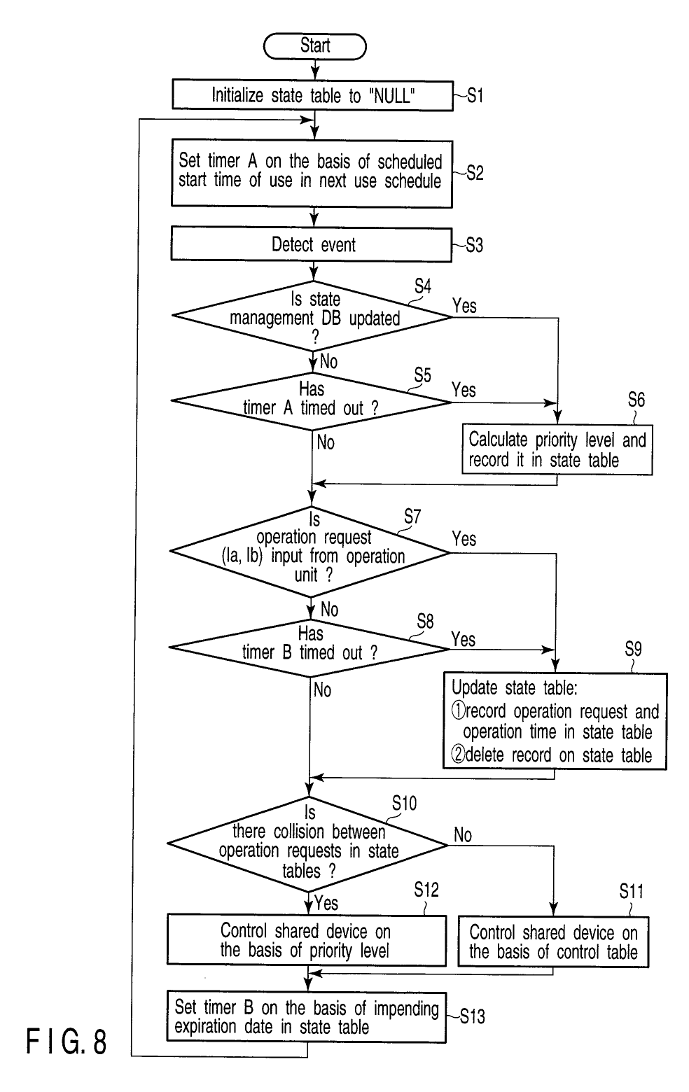

Each component of the priority controller 100 in FIG. 2 and the processing operation of each component will be described next with reference to the flowchart of FIG. 8.

When the priority controller 100 is started, the state tables 102a and 102b of the respective spaces are initialized to “NULL” (step S1).

The priority calculation unit 101 of the priority controller 100 includes timers (timers A and B). In the timer A, a scheduled start time of use or scheduled start time of use +/−α (α is predetermined time) in the next use schedule is set. In the timer B, an impending expiration date or expiration date +/−α in the state table is set.

Assume that a use schedule like that shown in FIGS. 3 and 4 is registered in advance in the state management DB 111 before May 10, 200_.

In step S2, the scheduled start time of use in the use schedule nearest to the current time is set in the timer A (step S2). In this case, the scheduled start time of use in the use schedule in FIG. 3, i.e., “May 10, 200_{—} 10:10”, is set.

The process then advances to step S3, in which the priority calculation unit 101 detects the following four events:

the elapse of the scheduled start time of use set in the timer A (the timeout of the timer A)

the expiration of the pending expiration date in the state table set in the timer B (the timeout of the timer B)

the update of the state management DB 111 (the update of the use schedule, the registration of new data, the deletion of data, and the like)

an operation request from the operation unit

If the priority calculation unit 101 detects the update of the state management DB 111 (step S4) or the timeout of the timer A (step S5), the process advances to step S6 to calculate the priority level of the updated/newly registered use schedule.

Assume that when the use of a conference room corresponding to a given use schedule is complete, the next use schedule for the conference room has been stored in the state management DB 111. In this case, the priority calculation unit 101 may calculate the priority level of an operation request for the conference room based on the next use schedule. Alternatively, after the use of a conference room based on a given use schedule is complete, the priority calculation unit 101 checks the use schedule stored in the state management DB 111 at predetermined time intervals. If the current time coincides with the scheduled start time of use in the use schedule or precedes the scheduled start time of use by a predetermined time, the priority calculation unit 101 calculates a priority level corresponding to each conference room.

In step S6, the priority calculation unit 101 reads out, for example, “use purpose” in the first conference room use schedule stored in the state management DB 111, and refers to a priority table like that shown in FIG. 7, which is stored in the state management DB 111, to search for a condition matching “use purpose”. If “use purpose” is “reception”, since the first condition in FIG. 7 is satisfied, the priority calculation unit 101 determines the priority level for the conference room as “1”. If there is no condition matching “use purpose”, the priority calculation unit 101 further reads out the executive position of each user listed in “user list” in the use schedule from the user management DB 112. If the user list includes a user having an executive position (above the level of a manager), since the second condition in a priority table like that shown in FIG. 7 which is stored in the state management DB 111 is satisfied, the priority calculation unit 101 determines the priority level for the conference room as “1”. If “use purpose” is not “reception” or the user list includes no executive user, the priority calculation unit 101 determines the priority level for the conference room as “0”. The priority calculation unit 101 determines a priority level for the second conference room in the same manner as described above.

The priority calculation unit 101 records the priority levels calculated for the respective conference rooms in the state tables corresponding to the respective conference rooms (step S6).

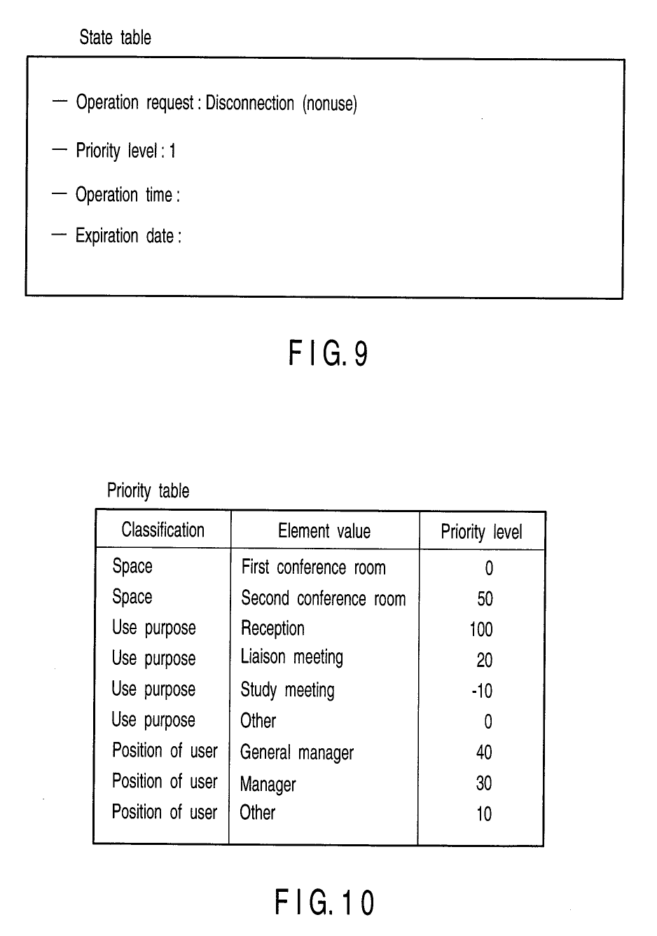

In each of the state tables corresponding to the respective conference rooms, as shown in FIG. 9, there are recorded the type of the latest operation request (the latest type) to the lighting device L1 (the type of the latest operation request from the conference room which has been detected by the priority calculation unit 101), the priority level, and the expiration date of the state table. This table may further include the time (operation time) when the latest operation request is detected. Note that the expiration date is the scheduled end time of use in the use schedule which is used for the calculation of the priority level. When step S6 is complete, the latest operation request, the priority level, and the expiration date are recorded in the state table.

For example, the user who has reserved the first conference room operates the operation unit 11a to input an operation request Ia around the scheduled start time of use of the first conference room R1 “10:10”. When the priority calculation unit 101 detects an operation request input from each of the operation units 11a and 11b, e.g., the operation request Ia (step S7), the process advances to step S9 to record the type of detected operation request Ia and the time of the detection of the operation request Ia in the state table 102a.

When the priority calculation unit 101 detects the timeout of the timer B (step S8), since the use of the conference room associated with the use schedule is complete, the process advances to step S9 to delete the record on the state table corresponding to the conference room and regard the operation request as “disconnection (nonuse)”. That is, the priority calculation unit 101 sets the state table to “NULL”.

Every time the priority calculation unit 101 updates the state tables 102a and 102b (i.e., whenever the priority calculation unit 101 detects a operation request, and whenever the use of a conference room is complete), the priority calculation unit 101 activates the device control unit 103. The activated device control unit 103 reads out the state tables stored in the state table storage unit 102, and refers to the first control table like that shown in FIG. 6 to check whether there is a collision between operation requests recorded on the respective state stables (step S10). If there is no collision, the process advances to step S11, and the device control unit 103 reads out the state of the lighting device corresponding to the combination of the operation requests recorded on the respective state tables from the first control table. If the readout state is “ON”, the device control unit 103 outputs a control signal O(y1) to set the lighting device L1 in the “ON” state. If the readout state is “OFF”, the device control unit 103 outputs a control signal O(y2) to set the lighting device L1 in the “OFF” state. That is, the lighting device L1 is controlled in accordance with the detected operation request Ia.

If the device control unit 103 determines in step S10 that there is a collision between the operation requests recorded on the respective state tables, the process advances to step S12.

In step S12, the device control unit 103 controls the lighting device L1 on the basis of the priority levels recorded on the respective state tables. That is, the device control unit 103 controls the lighting device L1 in accordance with one of the operation requests recorded on the state tables 102a and 102b which has a higher priority level. Assume that the operation request “conference” from the first conference room has the priority level “1”, and the operation request “presentation” from the second conference room has the priority level “0”. In this case, the device control unit 103 outputs the control signal O(y1) to set the lighting device L1 in the “ON” state in accordance with the operation request from the first conference room.

If both of the state tables have the same priority level, priority is given to one of the state table corresponding to the earlier “operation time” in one of the state tables. That is, the device control unit 103 controls the lighting device L1 in accordance with the type of operation request corresponding to the earlier “operation time”. Alternatively, priority may be given to an earlier “expiration date” in one of the state tables. Priority may also be given to a later “operation time” or “expiration date”. Alternatively, the current state can be maintained or the operation requests can be discarded. As described above, the user can make settings, in advance, about how to control the lighting device L1, when two operation requests have the same priority level. Such information (the method of controlling the lighting device L1 when operation requests have the same priority level) may be registered in the state management DB 111. For example, a user having the right to update the method of controlling the lighting device L1 when operation requests have the same priority level accesses the state management DB 111 from his/her terminal to register the control method in it.

When the above processing is complete, the process advances to step S13. In step S13, the priority calculation unit 101 refers to the state table for each space to set an expiration date near the current time in the timer B.

The process then returns to step S2. In step S2, if there is a use schedule that is running for each conference room, the scheduled start time of use in the next use schedule is set in the timer A. If this time has already been set, the process immediately advances to step S3. The subsequent processing is the same as that described above.

If it is determined in step S8 that the expiration date in the state table has passed (the timer B has timed out), the priority calculation unit 101 deletes the record on the state table in step S9. However, the present invention is not limited to this. If no schedule is registered after the expiration of the expiration date, and the continuation of the conference is detected by some means (e.g., human sensors 12a and 12b provided in the respective conference rooms), the priority calculation unit 101 may prolong the expiration date while the presence of any person in the conference room is detected by the human sensor.

According to the use schedules shown in FIGS. 3 and 4, since only the first conference room is used in the time from 10:00 to 10:30 and in the time from 11:30 to 12:00, no collision occurs between the operation requests, unlike in the above case. That is, the lighting device L1 is controlled in accordance with a type of an operation request from the first conference room.

In addition, this embodiment need not have the state table storage unit 102, and the operation units 11a and 11b in the respective spaces may include the state tables 102a and 102b. In this case, every time the priority calculation unit 101 or the device control unit 103 detects an operation request from each of the operation units 11a and 11b, the device control unit 103 detects a collision by inquiring of the record contents of the state table from each operation unit.

As described above, according to the first embodiment, when using a facility in which one device is shared in a plurality of spaces, it is possible to control the shared device so as to optimize its operation in accordance with the use states of the respective spaces based on the use purposes of the respective spaces, the attributes of the users, and the like.

In this embodiment, the facility provider (e.g., a rental service company which rents out a building or a room in a building) provides users (e.g., tenants) who use the facility with the spaces R1 and R2, the shared device L1 shared in the spaces, and the operation units 11a and 11b which are provided in the respective spaces and used to input a plurality of operation requests to the shared device L1.

The user management DB 112 and the state management DB 111 store information which can be arbitrarily set on the facility user side, e.g., a first control table like that shown in FIG. 6 and a priority table like that shown in FIG. 7 in addition to pieces of attribute information (the names, positions, and the like of users) of users like those shown in FIG. 5 and use schedules for the respective spaces like those shown in FIGS. 3 and 4.

When, therefore, using the above facility provided by the facility provider, a user can easily and conveniently use the facility by registering information suited to his/her convenience in the user management DB 112 or the state management DB 111 without changing the provided facility.

The above description has exemplified the case in which one device is shared in two spaces. However, the above description applies to a case in which one device is shared in three or more spaces. If, for example, a collision between operation requests is detected, it suffices to control the device in accordance with an operation request from a space with the highest priority level.

### SECOND EMBODIMENT

The different portions between the first and second embodiments will be described below.

In the first embodiment, a priority level takes two values, namely “0” and “1”. However, in practice, it is not so easy to determine a priority level. Consider, for example, a study meeting within a division with a general manager serving as an observer and a meeting with a customer. In this case, the latter can be said to be higher in priority than the former. If a collision occurs between meetings with customers, a meeting including a person with a higher position is likely to be more important. In addition, if the first conference room has a window and the second conference room has no window, lighting control is preferably performed for the second conference room with higher priority.

In order to reflect such determination, it suffices to use a method of determining the priority level of operation by assigning priority levels to the use form of a conference room, users, and the conference room itself and adding up the priority levels. More specifically, a priority table like that shown in FIG. 10 is used in place of the priority table in FIG. 7. Like the priority table in FIG. 7, the priority table in FIG. 10 is stored in, for example, a state management DB 111.

In the priority table in FIG. 10, priority levels are determined in accordance with conference rooms to be used, the use purposes of the conference rooms contained in use schedules corresponding to the conference rooms, attributes of users (e.g., the positions of users) of the respective conference rooms (stored in a user management DB 112), and the like.

In step S1 in FIG. 8, a priority calculation unit 101 calculates a priority level by using the priority table in FIG. 10 as follows.

First of all, the priority calculation unit 101 reads out the first conference room use schedule stored in the state management DB 111, and obtains information indicating that the conference room to be used is the “first conference room” and “reception” as “use purpose” from the use schedule. At this time, the priority calculation unit 101 also reads out the positions of the respective users listed in “user list” in the use schedule from the user management DB 112. The priority calculation unit 101 then obtains priority levels corresponding to “first conference room” and “reception” from the priority table shown in FIG. 10 which is stored in, for example, the state management DB 111. The priority calculation unit 101 further obtains priority levels corresponding to the positions of the respective users. The priority calculation unit 101 then calculates the total sum or average of all priority levels obtained in this manner. The priority calculation unit 101 sets this total sum or average as a priority level corresponding to the first conference room. Alternatively, weights may be determined in advance for the respective classification values in the priority table in FIG. 10. The priority calculation unit 101 may calculate the sum of the weighted values of all the priority levels obtained in the above manner and set the sum of the weighted values as a priority level corresponding to the first conference room.

Note that the assignment of priority levels like that shown in FIG. 10 can be determined at the discretion of a user (e.g., a tenant company or department), and hence can be customized in accordance with the form of operation in use at the workplace.

### THIRD EMBODIMENT

The different portions between the first and third embodiments will be described below.

The first embodiment has exemplified the case in which a lighting device L1 as a shared device takes only two states, namely the ON and OFF states. However, there is a device capable of adjusting brightness or temperature in a given range to one of a plurality of level values in a continuous or stepwise manner, such as a lighting device capable of stepless light control or an air conditioner. When such a device is to be used, a brightness or temperature value (level value) to be set in the device is obtained in consideration of a priority level (a priority level taking two values, i.e.,“0”/“1”, as in the first embodiment or a priority level taking multilevel values as in the second embodiment) at the time of collision.

Assume that the brightness (state) of a lighting device can take 100 steps from “0” (OFF) to “99” (FULL ON), and a collision has occurred between the operation request “conference” and the operation request “presentation” from the first and second conference rooms, as described above. In this case, a device control unit 103 obtains the state (level value) of the lighting device by using the priority level calculated in the first or second embodiment in step S7 in FIG. 8 as follows:

facility state=99×{priority of “conference”/(priority of “conference”+priority of “presentation”)}

Determining the level value of brightness of the lighting device L1 by using a ratio proportional to the priority level of each conference room (each operation request) in this manner makes it possible to control the device to become darker for a presentation with a higher priority level and become brighter for a conference with a higher priority level.

### FOURTH EMBODIMENT

The different portions between the first and fourth embodiments will be described below.

The first embodiment has exemplified the case in which one shared device is used. The fourth embodiment will exemplify a case in which a plurality of (two in this case) shared devices are shared in a plurality of spaces (first and second conference rooms R1 and R2).

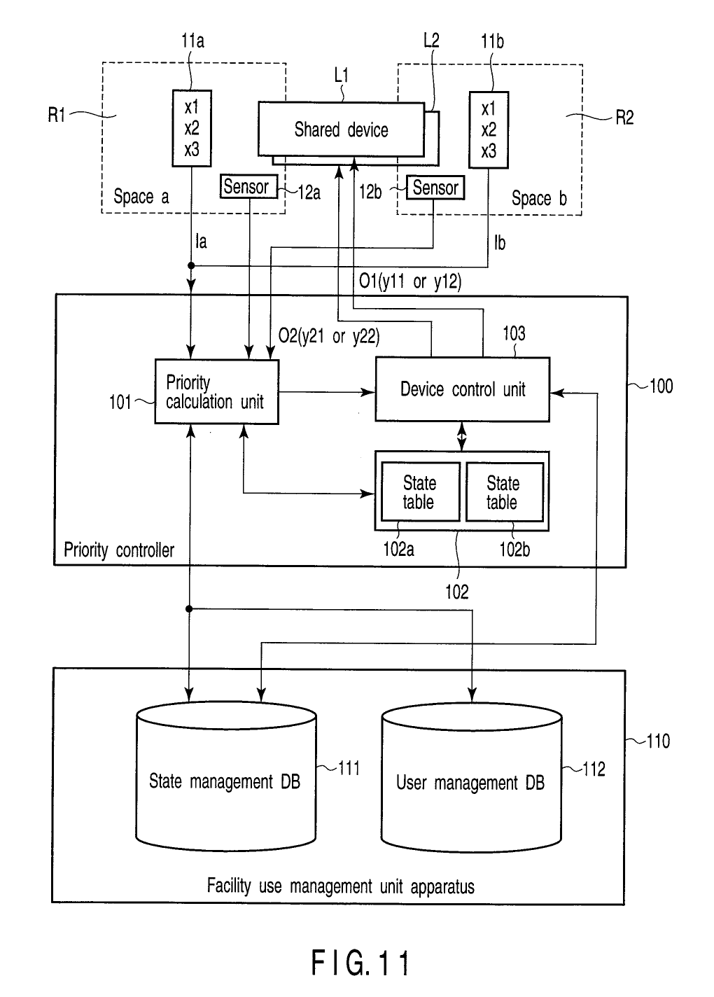

The same reference numerals as in FIG. 11 denote the same parts in FIG. 1, and only different portions will be described. Referring to FIG. 11, the fourth embodiment includes a curtain opening/closing device L2 which automatically opens/closes a curtain hanging from, for example, a window in the first conference room in addition to a lighting device L1. In this case, for the sake of simplicity, assume that the lighting device L1 takes states of two values, namely the ON state and the OFF state, and the curtain opening/closing device L2 takes states of two values, namely the open state and the closed state.

It is possible to set three types of common operation requests to each of the shared devices (the lighting device L1 and the curtain opening/closing device L2) to be input from operation units 11a and 11b. The three types of common operation requests to each device include individual operation requests (“ON”, “OFF”, and “NULL”) to the lighting device L1, and individual operation requests (“open”, “close”, and “NULL”) to the curtain opening/closing device L2. Such combinations can be arbitrarily set on the user side.

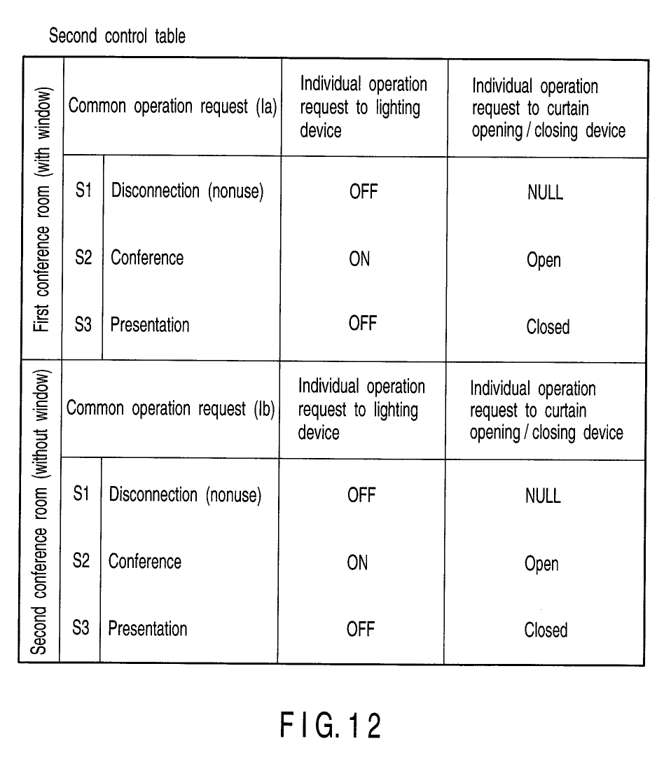

In this case, these three types of common operation requests are discriminated as “conference”, “presentation”, and “disconnection (nonuse)”. The second control table shown in FIG. 12 is obtained by defining the respective common operation requests by combining the individual operation requests to the lighting device L1 and the individual operation requests to the curtain opening/closing device L2. This second control table is stored in a state management DB 111.

In the second control table, three common operation requests may be defined differently for each of first and second conference rooms R1 and R2, or three common operation requests may be defined commonly for the first and second conference rooms R1 and R2, as shown in FIG. 12.

In the second control table in FIG. 12, “conference” is assigned to a combination of “ON” for the lighting device L1 and “open” for the curtain opening/closing device L2, “presentation” is assigned to a combination of “OFF” for the lighting device L1 and “close” for the curtain opening/closing device L2, and “disconnection (nonuse)” is assigned to a combination of “OFF” for the lighting device L1 and “NULL” for the curtain opening/closing device L2. Note that in this case, if the operation request is “NULL”, no control is performed for the curtain opening/closing device L2 (a control signal O2(y1, y2) is not output to the curtain opening/closing device L2). Consequently, the state of the curtain opening/closing device L2 does not change.

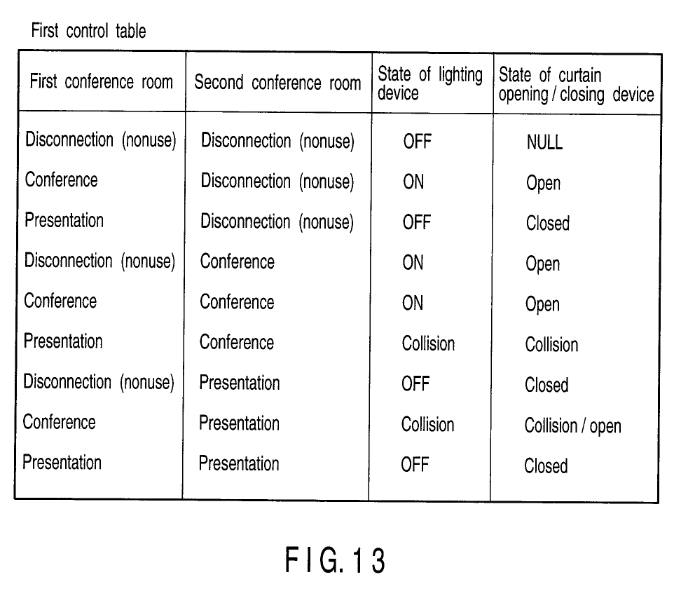

If, for example, a user having the right to register and update data in the second control table accesses the state management DB 111 from his/her terminal and registers/updates the second control table shown in FIG. 12, the state management DB 111 stores the first control table indicating the states (ON, OFF, and collision) of the lighting device L1 and curtain opening/closing device L2 which correspond to combinations of common operation requests from the operation units 11a and 11b in the respective conference rooms as shown in FIG. 13. A facility use management unit apparatus 110 may generate the first control table in FIG. 13 when a user registers/updates the second control table in FIG. 12, or the user may register/update the first control table like the second control table in FIG. 12.

As shown in FIG. 13, if a common operation request from one of the first and second conference rooms is “disconnection (nonuse)”, the lighting device L1 and the curtain opening/closing device L2 are set in a state corresponding to the other common operation request. If both common operation requests from the first and second conference rooms are “conference”, it suffices if the lighting device L1 and the curtain opening/closing device L2 are set in the ON state and the open state, respectively. If both common operation requests from the first and second conference rooms are “presentation”, it suffices if the lighting device L1 and the curtain opening/closing device L2 are set in the OFF state and the closed state, respectively.

Assume that a common operation request from one of the first and second conference rooms is “conference” and a common operation request from the other conference room is “presentation”. In this case, the common operation request “conference” requires to turn on the lighting device L1 and “open” the curtain opening/closing device L2, whereas the common operation request “presentation” requires to turn off the lighting device L1 and “close” the curtain opening/closing device L2. The common operation requests therefore collide with each other. That is, the state between the lighting device L1 and the curtain opening/closing device L2 is a collision state.

Upon detecting such a collision state in step S5 in FIG. 8, a priority controller 100 controls the lighting device L1 and the curtain opening/closing device L2 in accordance with one of the common operation requests from the two conference rooms which has a higher priority level in step S7 in the same manner as in the first and second embodiments.

Assume that a priority level takes two values, namely “1” and “0” as in the first embodiment. In this case, if the common operation request “conference” from the first conference room has the priority level “1” and the common operation request “presentation” from the second conference room has the priority level “0”, the priority controller 100 outputs a control signal O1(y11) to the lighting device L1 to set it in the “ON” state, and outputs a control signal O2(y21) to the curtain opening/closing device L2 to set it in the “open” state.

The above description applies to a case in which a priority level takes multilevel values as in the second embodiment. That is, if the priority level of the second conference room is higher than that of the first conference room, the priority controller 100 outputs a control signal O1(y12) to the lighting device L1 to set it in the “OFF” state and outputs a control signal O2(y22) to the curtain opening/closing device L2 to set it in the “closed” state.

Assume that a common operation request from the first conference room is “conference”, and a common operation request from the second conference room is “presentation”. In this case, the above collision state occurs. Since the first conference room has a window, even if the curtain opening/closing device L2 opens the curtain, and the lighting device L1 is turned off, no inconvenience may occur in a conference and presentation in the two conference rooms. In such a case, therefore, in step S7 in FIG. 8, if the difference between the priority levels (e.g., multilevel values) recorded in the first and second conference room state tables is not very large (for example, falls within a predetermined threshold), it suffices to perform control to set the curtain opening/closing device L2 in an open state and turn off the lighting device L1 instead of controlling the shared devices in accordance with the common operation request from the conference room with a higher priority level. Alternatively, if the priority levels recorded on the first and second conference room state tables are equal to each other, it suffices to perform control to set the curtain opening/closing device L2 in an open state and turn off the lighting device L1.

In addition, it suffices to determine the state (level value) of a shared device, of a plurality of shared devices as control targets, which can be adjusted to one of a plurality of level values, by using a ratio proportional to the priority level of each conference room (each operation request).

As described above, according to the first to fourth embodiments, when a facility in which a plurality of devices are shared in a plurality of spaces is to be used, the shared devices can be controlled to optimize the use of the facility in accordance with the use state of each space based on the use purpose of each space, the attributes of users, and the like.

The techniques of the present invention described in the first to fourth embodiments can be distributed as computer-executable programs by being stored in recording media such as magnetic disks (flexible disks, hard disks, and the like), optical disks (CD-ROMs, DVDs, and the like), and semiconductor memories. Causing the computer to execute the programs can make the computer function as the priority controller 100, state management DB 111, and user management DB 112.

What is claimed is:

1. A facility control system for controlling one or more devices shared in a plurality of spaces, a plurality of operation units being equipped in the spaces respectively, each operation unit configured to input a operation request for operating the devices; the system comprising:
a first memory to store, for each space, a use schedule including a reservation time, a use purpose of the space during the reservation time, and users of the space during the reservation time;
a second memory to store attribute information of each user;
a priority calculation unit configured to calculate a priority level of each space during the reservation time of each space based on at least one of the use purpose of each space and the attribute information of each user of each space;
a first detection unit configured to detect a type of the operation request input from each operation unit provided in each space;
a second detection unit configured to detect, whenever the type of the operation request is detected by the first detection unit for each space, a collision between types of the latest operation requests detected for respective spaces based on the types; and
a control unit configured to operate the devices according to one of the types which is detected for one of the spaces whose priority level is highest when the collision is detected.

2. The system according to claim 1, wherein the control unit operates the devices according to combinations of the types when the collision is not detected.

3. The system according to claim 1, wherein the priority calculation unit calculates, as the priority level of each space, a total sum, an average, or a sum of weighted values of a first priority level determined in advance for the use purpose in the use schedule and a second priority level determined in advance for the attribute information of each user.

4. The system according to claim 1, wherein the priority calculation unit calculates, as the priority level of each space, a total sum, an average, or a sum of weighted values of a first priority level determined in advance for each space, a second priority level determined in advance for the use purpose in the use schedule for the space, and a third priority level determined in advance for the attribute information of each user.

5. the system according to claim 1, wherein
at least one device of the devices is configured to be adjusted to a plurality of level values within a predetermined range in a continuous or stepwise manner, and
the control unit calculates a level value for the one of the devices by using a ratio proportional to the priority level of each space and adjusts the one of the devices to the level value when the collision is detected.

6. the system according to claim 1, wherein
the operation request includes a plurality of individual operation requests corresponding to the devices respectively, and
when the collision is detected and the priority levels of the spaces are equal to each other, the control unit operates each device according to the types.

7. The system according to claim 1, wherein the first detection unit detects the type of the operation request and a time when the type is detected, and
when the collision is detected and the priority levels of the spaces are equal to each other, the control unit operates the devices according to one of the types which is the type of the operation request detected at the earliest time or at the latest time.

8. The system according to claim 1, wherein when the collision is detected and the priority levels of the spaces are equal to each other, the control unit operates the devices according to one of the types which is detected for one of the spaces, an end time of the reservation time in the use schedule corresponding to the one of the spaces is the earliest or the latest.

9. The system according to claim 1, further comprising:
a third memory to store the types of the latest operation requests detected for respective spaces.

10. A facility control method for controlling one or more devices shared in a plurality of spaces, a plurality of operation units being equipped in the spaces respectively, each operation unit configured to input a operation request for operating the devices; the method comprising:
storing, in a first memory, a use schedule for each space, the use schedule including a reservation time, a use purpose of the space during the reservation time, and users of the space during the reservation time;
storing attribute information of each user in a second memory to store;
calculating a priority level of each space during the reservation time of each space based on at least one of the use purpose of each space and the attribute information of each user of each space;
detecting a type of the operation request input from each operation unit provided in each space;
detecting, whenever the type of the operation request is detected for each space, a collision between types of the latest operation requests detected for respective spaces based on the types; and
operating the devices according to one of the types which is detected for one of the spaces whose priority level is highest when the collision is detected.

11. The method according to claim 9, wherein operating operates the devices according to combinations of the types when the collision is not detected.

12. The method according to claim 9, wherein calculating calculates, as the priority level of each space, a total sum, an average, or a sum of weighted values of a first priority level determined in advance for the use purpose in the use schedule and a second priority level determined in advance for the attribute information of each user.

13. The method according to claim 9, wherein calculating calculates, as the priority level of each space, a total sum, an average, or a sum of weighted values of a first priority level determined in advance for each space, a second priority level determined in advance for the use purpose in the use schedule for the space, and a third priority level determined in advance for the attribute information of each user.

14. The method according to claim 9, wherein
at least one device of the devices is configured to be adjusted to a plurality of level values within a predetermined range in a continuous or stepwise manner, and
operating includes calculating a level value for the one of the devices by using a ratio proportional to the priority level of each space and adjusting the one of the devices to the level value when the collision is detected.

15. The method according to claim 9, wherein
the operation request includes a plurality of individual operation requests corresponding to the devices respectively, and
when the collision is detected and the priority levels of the spaces are equal to each other, operating operates each device according to the types.

16. The method according to claim 9, wherein detecting the type detects the type of the operation request and a time when the type is detected, and
when the collision is detected and the priority levels of the spaces are equal to each other, operating operates the devices corresponding to one of the types which is the type of the operation request detected at the earliest time or at the latest time.

17. The method according to claim 1, wherein when the collision is detected and the priority levels of the spaces are equal to each other, operating operates the devices in states corresponding to one of the types which is detected for one of the spaces, an end time of the reservation time in the use schedule corresponding to the one of the spaces is the earliest or the latest.
